(19) United States
(12) Patent Application Publication
(10) Pub. No.: US 2013/0088585 A1
(43) Pub. Date: Apr. 11, 2013

(54) SURFACE IMAGING WITH MATERIALS IDENTIFIED BY COLOR

(71) Applicant: Apekshit Pradeep Mulay, Richardson, TX (US)

(72) Inventor: Apekshit Pradeep Mulay, Richardson, TX (US)

(73) Assignee: TEXAS INSTRUMENTS INCORPORATED, Dallas, TX (US)

(21) Appl. No.: 13/269,031

(22) Filed: Oct. 7, 2011

(51) Int. Cl. H04N 7/18

(52) U.S. Cl. 348/79; 348/87

(57) ABSTRACT

An imaging system receives a height measurement and a resistance measurement, the measurements being made at a two-dimensional position on a surface. A display system maps the resistance to a predetermined material color value, and displays the height measurement and the material color value at the two-dimensional position on the surface.

### BACKGROUND

There is a general need for imaging the surface of composite materials. One particular example is imaging of the surface of integrated circuits for quality control. The size of many integrated circuit structures and components (for example, transistors) is below the limits of optical based imaging. One common surface imaging tool is Focused Ion Beam (FIB) imaging. Another common surface imaging tool is Scanning Electron Microscopy (SEM). In addition to imaging the shape of a surface, SEM may also provide characteristics of the materials at the surface, for example by using Energy Dispersive X-Ray spectroscopy (EDX). However, exposing a surface to charged beams may alter electrical characteristics of electronic components, or may damage integrated circuit structures, particularly as integrated circuit components and structures become smaller and smaller. For example, FIB imaging may implant Gallium ions or otherwise alter Field Effect Transistor (FET) characteristics. Similarly, SEM-EDX imaging can affect transistor parameters for advanced Complimentary Metal-Oxide Semiconductor (CMOS) technologies.

There is an ongoing need for improved microscopic surface imaging and surface materials analysis without damaging the surface being imaged and without changing electrical characteristics of the electronic components being imaged.

### BRIEF DESCRIPTION OF THE DRAWINGS

FIG. 1 is a simplified block diagram illustrating an example prior art embodiment of an atomic force microscope.

FIG. 2 is a simplified block diagram illustrating an example prior art embodiment of multiple probes arranged for measurement of resistance.

FIG. 3 is a simplified block diagram illustrating an example embodiment of an imaging system with a display of material types.

FIG. 4 is a flow chart of an example embodiment of a method for displaying material types.

### DETAILED DESCRIPTION

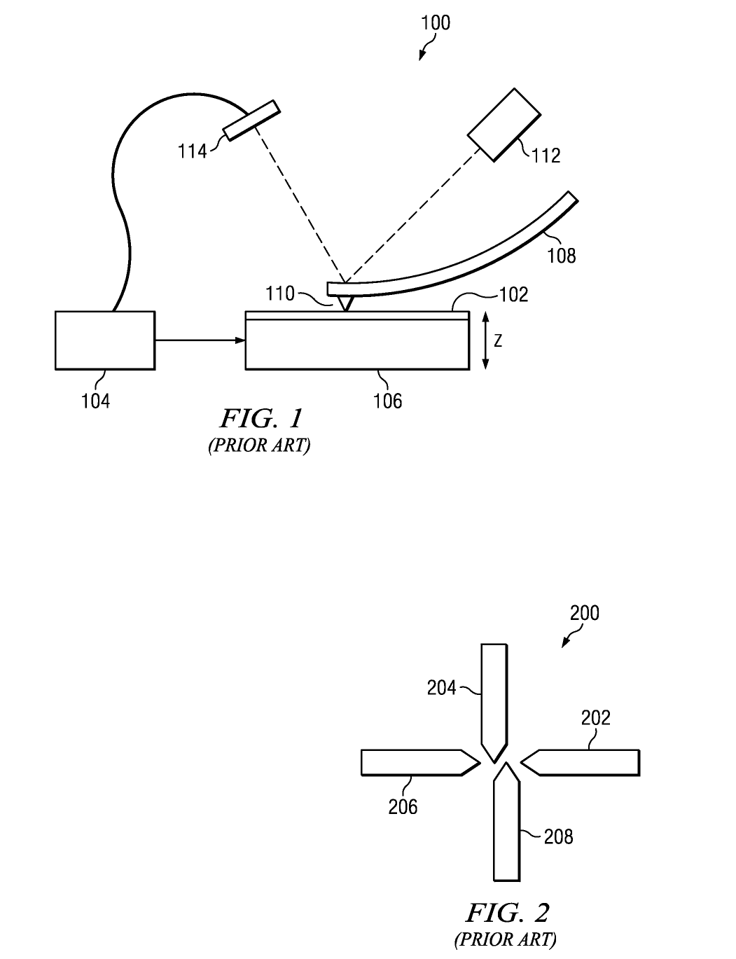

Another alternative surface imaging tool is an Atomic Force Microscope (AFM). FIG. 1 illustrates an example embodiment 100 of an AFM. In FIG. 1, a surface 102 is being scanned. A controller 104 controls a platform 106 that moves the surface 102 vertically (Z-dimension). A flexible cantilever 108 has a very small probe 110. When the probe 110 makes contact with the surface 102, the cantilever 108 bends slightly. In the embodiment illustrated in FIG. 1, a laser 112 projects a light beam that is reflected off the cantilever onto a photosensor array 114. Vertical deflection of the cantilever causes the reflected light beam to move on the photosensor array 114, providing a measure of the deflection of the cantilever, which in turn provides a measure of the force at the tip of the probe. In the example of FIG. 1, the photosensor array 114, the controller 104, and the platform 106 are configured as a closed loop system to maintain a constant force on the probe 110. There are other ways of measuring the deflection of the cantilever, including optical interferometry, capacitive sensing or piezoresistive cantilevers. Platform 106 may be, for example, a piezoelectric device. Other mechanisms (not illustrated) may move the cantilever 108 for scanning in an X-Y dimension, or move the surface 102 being imaged for scanning in an X-Y dimension, or both. For example, a piezoelectric device may move the surface being imaged in two dimensions (X, Y). As the probe and/or surface are moved in an X-Y dimension, the vertical height of the surface 102 changes, and the controller 104 moves the surface 102 vertically to maintain a constant force on the probe 110. Accordingly, the vertical height Z of the surface 102 at each X-Y position is measured by the controller 104. By maintaining a constant (relatively small) force on the probe, an AFM does not damage the surface being imaged if proper procedure is followed, and an AFM does not alter the electrical characteristics of electronic structures.

The AFM depicted in FIG. 1 has a single probe. Other specialized probes exist for measurement of additional characteristics. For example, an array of four probes (called a four-point probe) may be used to detect resistance in addition to force. FIG. 2 depicts an example arrangement 200. For example, a voltage may be placed across probes 202 and 206 causing a current to flow between them in the surface being imaged. The resistance of the surface being imaged results in a voltage gradient at the surface between the two probes. A portion of that voltage gradient is sensed by probes 204 and 208. Note that probes 204 and 208 are positioned between probes 202 and 206. The primary advantage of four-point resistance measurement is that very little current flows in the sensing probes (204 and 208) so that surface contact resistance of the sensing probes has very little effect on the measurement. This facilitates very precise measurement of resistance.

An AFM as in FIG. 1 with four-point resistance measurement as in FIG. 2 can provide a three-dimensional image of a surface overlaid with the resistance of the surface at each location. For a human operator performing quality control for an integrated circuit, it would be more useful to have an image that clearly identifies the material at each location. For example, it would be desirable to have an image clearly identifying materials such as silicon, polysilicon, silicon dioxide, tungsten, copper, etc. Some materials of interest may have similar resistances, so that the materials may not be visually distinct in an image representing just resistance.

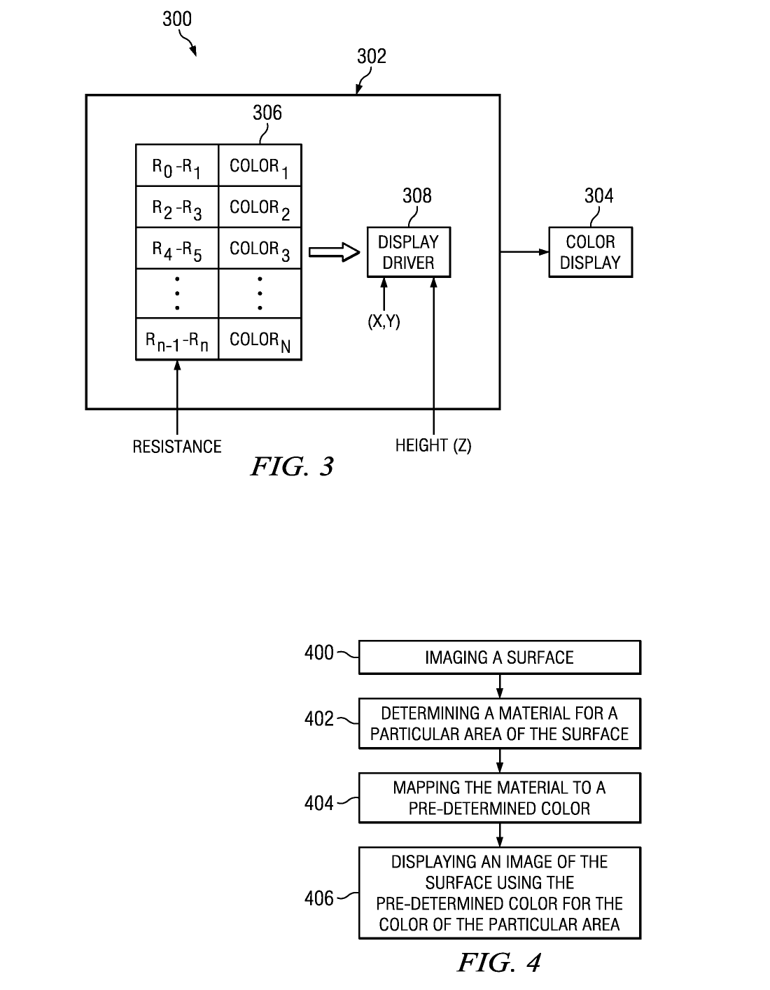

FIG. 3 illustrates an imaging system 300 for displaying surface material types. The imaging system 300 comprises an image processing system 302 and a display 304. The imaging processing system 302 receives a resistance value and a height (Z) value, where the resistance and height have been measured at a two-dimensional (X,Y) position on a surface. For example, the imaging system 300 may receive height and resistance from an AFM as in FIG. 1 using a four-point resistance probe as in FIG. 2. The image processing system includes a mapper, depicted as a look-up table 306 in FIG. 3. The mapper has pre-defined resistance ranges ((R₁-R₂)-(Rₙ₋-Rₙ)). Each received resistance is within a pre-defined range, and each pre-defined range corresponds to a pre-defined material color (COLOR₁-COLOR_{N}). For each two-dimensional position being measured, the system maps the corresponding resistance to a material color, and sends the material color to a display driver 308. The display driver drives the display 306, which displays a surface, showing the material color and height (Z) at each measured two-dimensional (X,Y) position on the displayed surface. When used for analysis of the surface of an integrated circuit, only those materials that are used in manufacturing of integrated circuits will have a known color mapping for a specific resistance value.

Assume, for example, that the resistance of tungsten falls within the first resistance range (R₁-R₂), and that the pre-defined color for tungsten is orange. Assume further, for example, that the resistance of polysilicon falls within the second resistance range (R₃-R₄), and that the pre-defined color for polysilicon is light green. At a first two-dimensional position (X_{A}, Y_{A}), a four-point probe measures a resistance R_{A} and a height Z_{A}. Assume R_{A} falls within the first resistance range (R₁-R₂). At a second two-dimensional position (X_{B}, Y_{B}), the four-point probe measures a resistance R_{B} and a height Z_{B}. Assume R_{B} falls within the second resistance range (R₃-R₄). At position (X_{A}, Y_{A}), the system displays Color, (orange) and height Z_{A}, and at position (X_{B}, Y_{B}), the system displays Color₂ (light green) and height Z_{B}.

Height (Z) may be shown on a two-dimensional image by varying intensity (for example, increasing height may result in a lighter less-saturated color or higher intensity). Alternatively, the display may depict the surface at an acute angle so that height is visible. Alternatively, the system may rotate the resulting image in three-dimensional space to facilitate viewing of the height data.

Note that the material colors COLOR₁-COLOR_{N} may be chosen to enhance distinctiveness in the display and do not necessarily correspond to actual material colors. In particular, colors may be chosen to increase the visibility of certain types of defects or particle contaminants. For example, the color of a conductive trace may be made distinct from a color for an underlying substrate to increase the visibility of voids in a conductive trace.

The imaging system 300 may be an AFM or part of an AFM. The image processing system 302 may receive resistance as an analog signal (for example, a voltage) to be converted by an analog-to-digital converter, or may receive a digital value. The image processing system 302 may receive two-dimensional (X,Y) position data from a separate system, such as a surface positioning stage. Alternatively, the image processing system 302 may generate the (X,Y) position. For example, the image processing system 302 may also serve as a controller for an AFM and may control the X,Y position of the surface being imaged. The image processing system 302 may comprise a controller, a processor, a microcontroller, a microprocessor, a digital-signal processor, an application-specific integrated circuit, logical modules, or other types of hardware or software capable of performing a mapping of resistance to material color. The mapping may be performed by a look-up table as depicted by table 306 in the example of FIG. 3, or by hardware comparators, or by a series of if-then-else statements in software, or other logic or software. The display driver 304 may be a separate device or may be integrated.

A system for scanning the topology of an integrated circuit along with identifying the materials at the surface is particularly useful in quality control. Scanning with an AFM may be automated and may take place in-situ during manufacturing. In particular, scanning with an AFM may take place in a vacuum, and may be repeated as the surface is modified during normal manufacturing process steps. Actually, scanning in a vacuum is preferred, since non-vacuum ambient conditions may result in an oxide layer that would interfere with resistance measurement, and the surface would need to be buffered or etched to remove the oxide layer. The topology and resistance results may be useful independently from other testing (for example, detection of voids or contaminants), or may be combined with other testing. For example, if a circuit fails a functional test, then an earlier surface scan may be examined to see if a defect can be identified that might have caused the failure.

FIG. 4 illustrates a method for displaying material type for a surface. At step 400, a surface is imaged. At step 402, a material is determined for a particular area on the surface. At step 404, the material is mapped to a pre-determined color. At step 406, an image of the surface is displayed using the pre-determined color for the color at the particular area.

What is claimed is:

1. An imaging system, comprising:
an image processing system, receiving a height value and a resistance value, the height and resistance having been measured at a two-dimensional position on a surface, the image processing system comprising a mapper that maps the resistance value to a material color; and
a display driver, driving a display, and displaying the material color and the height at two-dimensional positions on the surface.

2. The imaging system of claim 1, further comprising:
a probe; and
a system to move the surface into contact with the probe.

3. The imaging system of claim 2, where the probe is a four-point probe.

4. The imaging system of claim 2, where the surface is a surface of an integrated circuit, and where the material color corresponds to a material in the integrated circuit.

5. The imaging system of claim 2, where the mapper comprises a look-up table, the look-up table further comprising a table of resistance ranges and a table of material colors, with a one-to-one mapping of material colors to resistance ranges.

6. The imaging system of claim 2, where the height is displayed as an intensity of the material color.

7. The imaging system of claim 2, where the imaging system moves the surface to the two-dimensional position at which the height and resistance are measured.

8. The imaging system of claim 1, where the surface is a surface of an integrated circuit, and where the material color corresponds to a material in the integrated circuit.

9. The imaging system of claim 1, where the mapper comprises a look-up table, the look-up table further comprising a table of resistance ranges and a table of material colors, with a one-to-one mapping of material colors to resistance ranges.

10. The imaging system of claim 1, where the height is displayed as an intensity of the material color.

11. The imaging system of claim 1, where the imaging system moves the surface to the two-dimensional position at which the height and resistance are measured.

12. A process, comprising:
imaging, by an atomic force microscope, a surface;
determining a material for a particular area of the surface;
mapping the material to a predetermined color; and
displaying an image of the surface using the pre-determined color for the color of the particular area.

13. The process of claim 12, the step of determining further comprising:
measuring a resistance at the particular area of the surface; and
determining that the resistance is within a range of resistance corresponding to the material and the predetermined color.

14. The process of claim 13, the step of measuring further comprising measuring a voltage along the surface using a four-point probe.

15. The process of claim 12, further comprising:
determining a height of the surface at the particular area; and
displaying the height of the surface at the particular area in the image of the surface.

16. The process of claim 15, the step of displaying the height further comprising varying the intensity at the particular area according to height.

17. A process, comprising:
imaging, a surface of an integrated circuit;
determining a material for a particular area of the surface;
mapping the material to a predetermined color; and
displaying an image of the surface using the pre-determined color for the color of the particular area.

18. The process of claim 17, the step of determining further comprising:
measuring a resistance at the particular area of the surface; and
determining that the resistance is within a range of resistance corresponding to the material and the predetermined color.

19. The process of claim 17, further comprising:
determining a height of the surface at the particular area; and
displaying the height of the surface at the particular area in the image of the surface.

20. The process of claim 19, the step of displaying the height further comprising varying the intensity at the particular area according to height.
